(19) United States
(12) Patent Application Publication
(10) Pub. No.: US 2014/0173977 A1
(43) Pub. Date: Jun. 26, 2014

(54) PRODUCTION METHOD OF THE SUBSTRATE FOR THE GROWING OF CHAMPIGNONS AND OTHER CULTIVATED MUSHROOMS

(71) Applicant: Kestutis Juscius, Siauliu r. (LT)

(72) Inventor: Kestutis Juscius, Siauliu r. (LT)

(73) Assignee: UAB "EKO INVEST", Siauliai (LT)

(21) Appl. No.: 14/236,295

(22) PCT Filed: Jul. 31, 2012
(86) PCT No.: PCT/IB2012/053913

§ 371 Date: Jan. 30, 2014

(30) Foreign Application Priority Data
Aug. 1, 2011 (LT) 2011 069

(51) Int. Cl. A01G 1/04

(52) U.S. Cl. CPC A01G 1/04
USPC 47/1.1

(57) ABSTRACT

The aim of the invention is to create a fundamentally new method of the substrate production, which would include the following: the processing of the parent materials, containing lignocellulose (for example, straw), by applying the methods of the primary processing (for example, steam explosion) in order to decompose the said parent material into the lower-level components; possible removal of the carbohydrates of the group C₅ from the processed mass of lignocellulose; extrusion, pasteurization and sterilization of the initial substrate; adding of the components to the wetted initial substrate, its enrichment of materials necessary the growth of the mycelium and mushrooms; undersowing of the mycelium and its stirring in the volume of the prepared substrate. The selectivity and resistance of the substrate to diseases can be improved by inoculating and incubating the mass of ligninocellulose, (processed by the aforementioned methods) with thermophilic fungi, the development thereof corresponds to the optimum temperature of 45° C. The amount of the useful derivatives/complexes of cellulose and hemicellulose is approximately two times larger in the substrate produced by using the new method in comparison the substrate which is produced by applying the conventional composting method; the preparation process of the new substrate is significantly shorter; during the preparation of the new substrate lignocellulose is broken down artificially up to the desired level of degradation; after the processing, lignocellulose absorbs water significantly better. It is possible to dry, compact the subtract, also to prepare it for transportation and/or storing.

### TECHNICAL FIELD

The invention refers to the growing of champignons and other cultivated mushrooms, especially to the procedures of the substrate preparation. The new method of the substrate production/preparation presented herein and equipment suitable for the implementation of that method can be used with champignons (Agaricus bisporus, Agaricus bitorquis), oyster mushrooms (Pleurotus ostreatus), Bruno Shimeji, Maitake, Erengyii, Shi-take, Lentinula edodes, Pleurotus spp., Auricularia spp., Vovariella volvacea, Flammulina velutipes, Tremella fuciformis, Hypsizigus marmoreus, Pholiota nameko, Grifola frondosa and with other cultivated mushrooms which require during the growing process to prepare an appropriate medium, that is, a substrate for various species of the cultivated fungi to grow.

### BACKGROUND ART

The invention relates not only to the traditional and improved growing process of champignons and other cultivated fungi but also with the parent materials (for example, straw of various plants, hay, cottonseed hulls, corn stalks, wood chips or other materials containing lignincellulosic biomass) and their application in the production of the substrate by applying various methods of processing, for example, steam explosion, application of concentrated/diluted acids, application of thermo-chemical gasification, isolation/decomposition of the components of the said primary materials, application of microwaves, application of steam, application of hot liquid/water, etc. Therefore in this chapter several different fields will be analysed, which are related with the presented new method of the substrate production.

The Chinese patent No. CN 101736646, published in 16 Jun., 2010, is known. In the patent the method of the straw and reed processing by applying the stream explosion method is analysed, during which a soft mass of cellulose is obtained. This method also includes the preparation of the parent materials by washing them with water and soaking them in the solvent of organic nature. The preparation of such cellulose mass does not pollute the environment, is fast and efficient. However, the patent covers only the preparation and use of crude cellulose mass in agriculture by disposing such waste as straw, reeds, etc.

The Chinese patent No. CN101643796, published in 10 Feb., 2010, is also known. In the patent the method of use of straw as biomass by applying the steam explosion method is analysed, during which the decomposition of the primary materials into lower level components, for example, to polyxylose and to xylose. Later, during the of the further processing of fermentation, ethanol is extracted, while from the residual materials lignin is extracted. The application of the method allows to dispose waste and to produce ethanol and lignin in an effective, cheap and quick way. However, the patent is focused only on the disposal of biomass waste and describes certain stages of production of ethanol and lignin. There is no connection with the stages of mushroom growing by applying the steam explosion method.

The Chinese patent No. CN101608412, published in 23 Dec., 2009, is known. In the patent the decrystallization process of the primary materials (biomass) is described, during which the primary material is decomposed into lower level components by applying the steam explosion method together with microwave processing. Also, the patent covers the separation of the soft and hard components of the obtained crude mass. The patent provides improved decrystallization (through integration of enzymes) of the primary materials and isolation of the soft and hard components of the obtained crude mass. However, there is no connection with mushroom growing.

In the world, a lot of methods of the processing of the primary materials are known, they have been tested during the beginning of the last century (some other even earlier), however, in time and in order to satisfy new needs, the new applications of these methods, differing by new properties and special features, (for example, steam explosion technology, processing by concentrated/diluted acids, application of thermochemical gasification, isolation of the components of the said primary materials, application of microwaves, application of steam, application of hot liquid/water, etc.) were developed.

The European patent No. EP0434159, published in 26 Jun., 1991, is known. In the patent the so called system of tunnels/bunkers is described, which allows to separate the stages of compost pasteurization and mycelium incubation from the growing of mushrooms. However, this type of tunnels has few problems. One of the problems is very high power consumption for air blowing as the layer of the preliminary material is very thick (up to 4 meters). Other problem: nevertheless, in such tunnels uniform distribution of oxygen if not ensured This occurs because the height for placing the compost is too great and in the material, in some areas, the places of high density (jammed) form while in other places cracks form through which an excessive amount of airflow enters. Due to the said places of high and low density, which are formed locally, the homogeneity of the material in the whole substrate mass is unattainable.

The closest to the technical level is the Lithuanian patent LT5734, published in 27 Jun., 2011. In the patent a fundamentally new production method of champignons and other cultivated mushrooms is described which covers relevant aeration equipment and its use. This production method is very effective at resolving problems of aeration, temperature and homogeneity control in material, also at the same time significantly reduces power consumption. Such method of production/growing helps to reduce champignon's growth time, increases production volume and in this way allows to reduce the cost of an end product (mushrooms). Also the problem of harmful microorganisms is reduced, and additional/specialized use of such a method allows additionally to save electricity. When using the mode of production described in this application, the production of mushroom substrate is more standardized, less uncontrolled processes remain, the technology of the production of mushroom substrate becomes available to every mushroom grower. This technology is very important in terms of environmental point of view, that is, electricity demand for growing of one kilogram of mushrooms is significantly reduced and it is possible to completely abandon the usage of fossil fuels because it is possible to use the heat released during the process of the preparation of the substrate.

A fundamentally new production method of substrate, suitable for growing of various cultivated mushrooms, is described below. The essence of the production method is a completely different method of the production of the aforementioned substrate.

### DISCLOSURE OF INVENTION

### Technical Problem

### SOLUTION TO PROBLEM

### Technical Solution

The invention aims at developing a fundamentally new production method of substrate, suitable for growing various mushrooms (and champignons).

The essence of the invention is new production method of substrate. The method covers the following:
1. 1) The processing of the parent material (for example, straw of various plants, hay, cottonseed hulls, wood chips or other materials containing lignocellulosic biomass) by applying one of the known methods of the primary processing of lignocellulose (for example, steam explosion method, use by concentrated/diluted acids, application of thermochemical gasification, isolation of the components of the said primary materials, microwave processing, application of steam, application of hot liquid/water, etc.) in order to decompose/process the said parent material into lower level components and to obtain the raw material;
1. 2) the carbohydrates of the group C5, which break down during the process of hemicellulose hydrolysis (or other effect), can be removed from processed lignocellulosic biomass (raw material);
1. 3) after the process of the potential removal of the group C5, the aforementioned raw material (hereinafter referred to as the primary substrate) is squeezed out and/or wetted to the required level (degree) of moisture;
1. 4) if additional, enriching components of the substrate, which are planned to be mixed with the aforementioned primary substrate, are not microbiologically clean, they are pasteurized or sterilized in order to destroy all pathogenic microorganisms (of infection) therein;
1. 5) the said substrate enriching components will be mixed to the wetted primary substrate. The components enrich the primary substrate with proteins, minerals, and other materials necessary for the growth of mycelium and mushrooms;
1. 6) the mycelium is undersown (inoculated) to the wetted and enriched primary substrate (after all these operations it can be referred to simply as the substrate). The mycelium is mixed evenly/uniformly over the entire volume of the substrate and locally in a specific part of the substrate.

The further process of the mushroom growing is known at the technical level and has not been detailed further.

The new production method of substrate guarantees such special features of the invention:
1. 1) In the substrate, produced in a new way (the new substrate), the amount of the useful derivatives/complexes of cellulose and hemicellulose is approximately two times larger than in comparison with that of the substrate which is produced in a usual composting method;
1. 2) The process of preparation (production) of the new substrate is significantly shorter than that of the substrate produced by composting method;
1. 3) During the preparation of the new substrate lignocellulose is broken down artificially up to the desired level of degradation when during the application of the usual composting method it is not possible to reach an even same degree of the decomposition and the level of the degradation of each part of the substrate.
1. 4) When applying the method of the invention, after the processing, lignocellulose absorbs water significantly better thus is it easier to reach the level of humidity of the substrate.

When applying the new production method of substrate, it is possible to dry the substrate produced by the new method, to compact (by applying currently known methods, for example, pressing, pelletizing, etc.), also to prepare for transportation to other (distant) plants and for storing. The dried and compacted substrate is light and under appropriate external conditions can be stored for a long time. Later, the said dried substrate can be wetted and again fully used in the process of the mushroom growing as the main substrate or as a supplement/additive, enriching other substrates, to which the said substrate is added.

### ADVANTAGEOUS EFFECTS OF INVENTION

### Advantageous Effects

### BRIEF DESCRIPTION OF DRAWINGS

### Description of Drawings

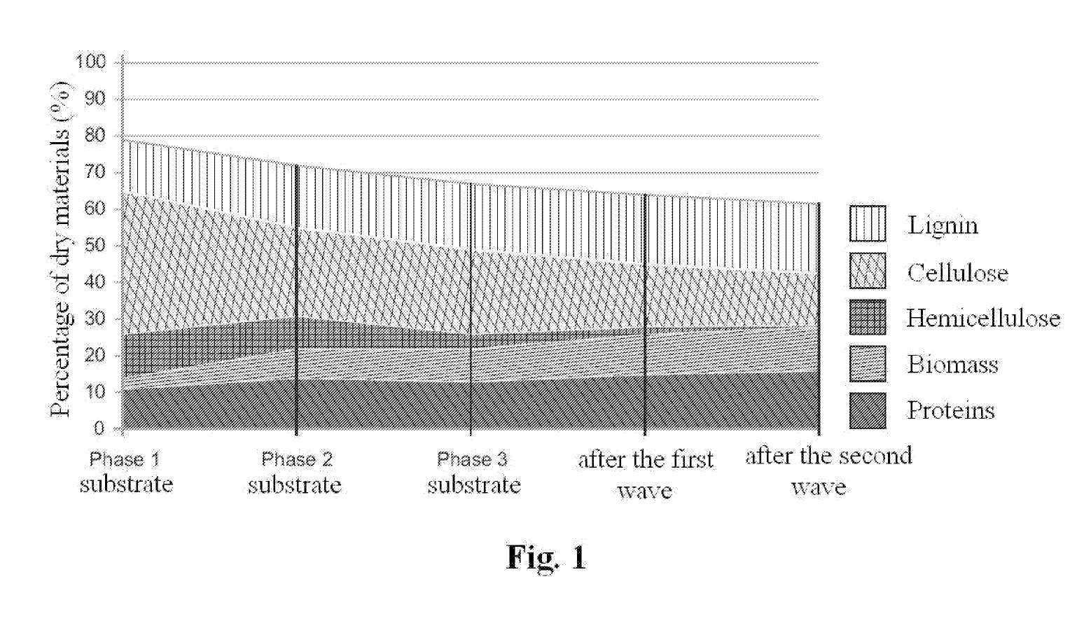

In the FIG. 1 a diagram is presented where the percentage of the substrate material in different stages of growing (in terms of the first, second and third stages of the substrate preparation and later stages of the mushroom growing) is indicated.

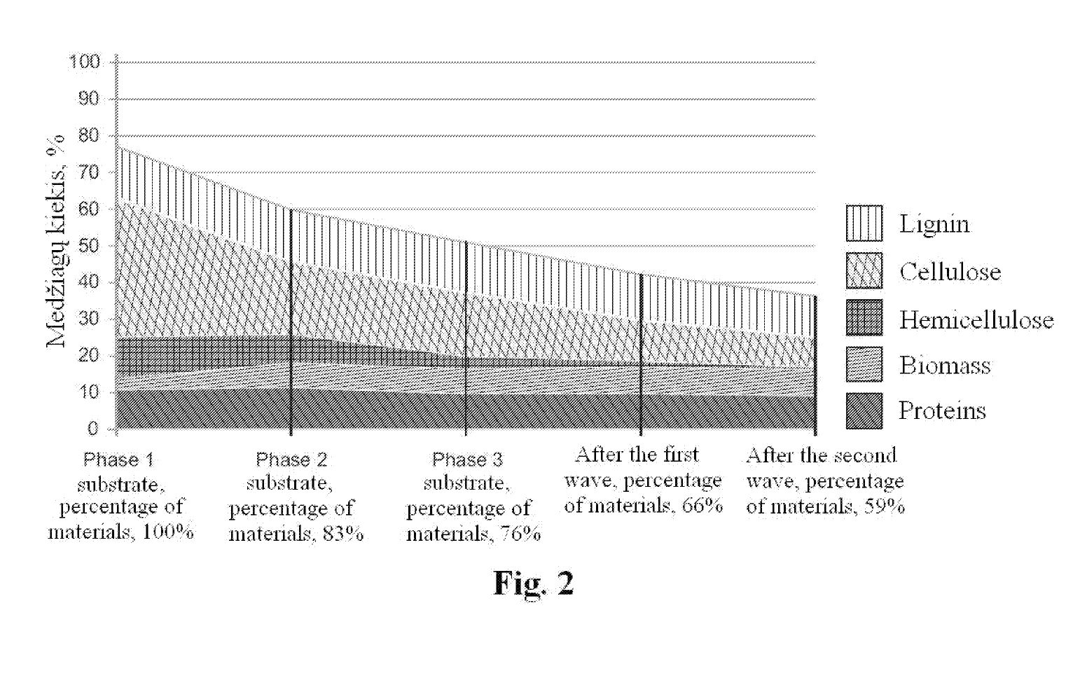

In the FIG. 2 a diagram is presented where the change in the amount of the materials during different stages of the champignon growing (in terms of the first, second and third stages of the substrate preparation and later stages of the mushroom growing) is indicated.

### BEST MODE FOR CARRYING OUT THE INVENTION

### Best Mode

It is assumed that the roots of the champignon growing go back to the year 1700, however purposeful and deliberate growing of mushrooms started in the 19th century in France. And although at that time the champignon growing methods were of low productivity, of insufficient homogeneity of the material in all stages of the champignon growing, dangerous in terms of bacteria, spores and diseases, dirty and followed by a strong unpleasant smell emitted by compost (as growing of champignons is a certain activity of waste utilization when the nutrient material designed for the growing of champignons is based on the mixture of straw and horse or chicken manure), it was only the beginning of the champignon growing after which all activities to develop and improve champignons started. The initial system of the champignon growing formed in China, but over the time it moved to Europe and America. At the end of the 19th century the problems of the sterilization of the champignon growing were addressed, at the beginning of the 20th century the conception of the shelves emerged which became the basis and standard in the field of the champignon growing both in America and Europe, while in 1970 the technology of the fermentation rooms (tanks) or tunnels was developed which allowed to separate the stage of the compost pasteurization and mycelium incubation from the mushroom growing, that is, the pasteurization and incubation of the mushroom substrate moved to separate, specially equipped rooms. Also, recently (the Lithuanian application 2010-083) the conception of the shelf aeration was developed which substantially improved the growing process of all cultivated mushrooms.

And this invention analyses the new production method of the substrate. It is known that one of the most important growing stages of the said grown mushrooms is the preparation of an appropriate medium (substrate) which is appropriate for the growing of a specific mushroom species or subspecies. The main food of the mushroom fruit body is the lignin and cellulose components of the substrate while the following two components of the substrate which are especially important in order for mycelium to proliferate and for fruit bodies to form and grow: cellulose and hemicellulose compounds because these two materials are mostly used during the process of mushroom growing (FIG. 1, where a diagram is presented, in which the percentage of the substrate material during different stages of the champignon growing process is shown).

Also, in order for mycelium to grow other materials are also important, for example:

proteins, lipids, minerals however the demand for them is very different depending on the species of the cultivated mushrooms. The demand for cellulose and hemicellulose is greatest in case of any cultivated mushroom species. The preparation of the growing mediums (substrate) for different cultivated mushrooms also slightly differs (for example: Lentinula edodes, Pleurotus spp, Auricularia spp., Vovariella volvacea, Flammulina velutipes, Tremella fuciformis, Hypsizigus marmoreus, Pholiota nameko, Grifola frondosa and for many other species). Also, the quantities of various materials, composing the substrate, differ. But in general, the preparation of the substrate usually consists of the following steps:
1. a) mixing and stirring of various initial components;
1. b) wetting of the formed mixture to the required level of moisture;
1. c) pasteurization or sterilization in order to destroy pathogens of the competitive microflora;
1. d) cooling to the incubation temperature;
1. e) undersowing and mixing of mycelium in the cooled medium (substrate);
1. f) incubation of the substrate (in optimal conditions for mycelium, which are different for each mushroom species);

After the growing medium, the substrate for full mycelium colonization is placed in the room designed for the purpose, where optimal conditions are maintained for a specific species of cultivated mushrooms. Later, the mushrooms grow and are gathered.

Currently the known champignon growing method consists of five phases/parts: preparation of initial compost mass (phase I), pasteurization of compost and formation of the prepared feeding medium (phase II), germination, incubation of mycelium (phase III), formation of germs (phase IV) and growing of mushrooms and gathering of the harvest. During the phase I the initial compost mass is prepared. It is based on material of organic nature, for example, horse and/or chicken (bird) manure mixed with straw and water. Additionally calcium mineral additives are mixed. Other minerals usually already exist in insufficient quantities in the aforementioned materials. Everything is mixed and this mixed mass is placed in the prism-shaped piles of compost and into special rooms—bunkers (tunnels). Here the composting takes place by supplying oxygen to prism-shaped piles in a natural way or to tunnels/bunkers in a forced way. At the beginning of the phase II the compost is pasteurized. The high temperature of 56-60° C. together with ammoniac released from the compost during the process destroys pathogenic mushrooms and microorganisms however during the process the beneficial microorganisms are saved. The beneficial microorganisms (the most beneficial are thermophilous fungi), which survived during the pasteurization, proliferate in the optimal temperature of 45-50° C. They process materials in the compost and form optimal medium for the later proliferation of the champignon mycelium. During the phase III, the mycelium is germinated and incubated into the prepared feeding medium, during the phase IV germs form and in the phase V the growth of the end product (champignon) and gathering of production takes place.

It is known at the current technical level that the growing medium for the champignon-type mushrooms (for example Agaricus bisporus, Agaricus bitorquis) is prepared by the method of composting. Also, there is a method for preparing the Till substrate which was developer in 1962. When using the Till method, the substrate, consisting mostly of straw and the mixture of the organic nitrogen sources, was not composted only sterilized (after mixing the components in the initial substrate mass). However this method was failed to be successful as after sterilization of such a substrate the lignocellulose complex of the existing materials was not available for enzymes of the mycelium. The method failed to be moved to the commercial level.

The aim when applying the method of composting is to increase the decomposition of the lignocellulose complex during the said phases I and II. Under the influence of thermophious fungi, bacteria, ammoniac, relatively high (up to 85° C.) temperatures, and alkaline reactions, the complex of lignocellulose materials, located in the substrate, stratifies and partially decomposes. The aim during the process of composting is to increase the substrate selectivity and to guarantee for the mycelium of the champignon-type mushrooms (for example, Agaricus bisporus, Agaricus bitorquis) an easier accessibility (acquisition of relevant materials).

The process of composting is very old and sufficiently perfected however there are some disadvantages.

In order for materials, which are in the lignocellulose complex, to be more accessible to the enzymes of the mycelium, the aim during the composting is to create an appropriate medium, suitable for thermophilic bacteria, which in the environment of fungi, ammoniac and alkaline medium breaks down the natural protective compound, created by nature, having the main components/materials required for the cellulose and hemicellulose fungi, which are not accessible due to the compounds of lignin, wax and silicon. During the aforementioned process of decomposition the beneficial complexes of the cellulose and hemicellulose materials however the process of composting also consumes a lot of these (cellulose and hemicellulose) materials. Fig. The diagram 2 is presented where the change of the amount of the substrate materials in different stages of the champignon preparation and growing is indicated.

The figures above (FIGS. 1 and 2) show that the highest amount of cellulose and hemicellulose is lost during the production phases I and II. After the mixing of the parent materials, the mixture has approximately 50 percent of hemicellulose and cellulose, when calculating from the total amount of dry materials. After the phase II of the production only approximately 35% remains, when calculating from the total amount of dry materials (FIG. 1), but since at the same time the dry material content also decreases (due to the process of material decomposition: disruptive activity of lignocellulose of the temperature bacteria and mushrooms) during the first and second phases of the composting almost half of the initial content is lost in hemicellulose and cellulose absolute (quantitative) value. The fact is best illustrated by the FIG. 2, in which the reduction of the content of the dry materials during the composing phases of the production is presented and where the content of the materials is indicated in absolute values by taking into consideration the compost during the first phase of the production. Just during the first and second phases of the production approximately 50 graduations (parts) to 30 graduations (parts) are lost (in absolute value). Later, during the third phase of the production, a relatively small amount of useful materials is lost, approximately 5 graduations which are used for the process of the mycelium incubation. During the growing of fruit bodies, after gathering the first and the second wave of the mushroom growing, when approximately 80% of all yield is gathered, the amount of the dry materials decreases from 25 graduations to 12 graduations (FIG. 2). This allows to make the following conclusion: 13 graduations of the materials are lost during the growing of the fruit body when during the preparation of the compost (during the first and second phase) 20 graduations, that is, useful materials, cellulose and hemicellulose, are lost, during the preparation of the substrate (20 graduations) more is lost than used beneficially, that is, for the growing of fruit bodies (13 graduations). We can see that during the undersowing of the mycelium to the substrate (the end of the second phase of the compost production) only approximately 35% of useful (cellulose and hemicellulose) materials remain in the composted and pasteurized medium when calculating from the total quantity of the dry materials in the substrate (FIG. 1) which are most necessary for the mushrooms during the growing of fruit bodies. Meanwhile the initial mixed components have more than 50% cellulose and hemicellulose in the context of the total mass.

During the process of composting a significant quantity of noxious gases are released which adversely affect the environment and emits specific, unwanted odours.

In order to guarantee homogeneous composting it is necessary to stir the substrate medium up few times. It requires a lot of special composting equipment, premises, knowledge, fuel and electricity. Therefore the process of composting have turned from primitive waste treatment into an expensive set of complex technological solutions which have become necessary in order to guarantee performance indicators required for the process. The more complex composting technology have increased capital costs necessary for investments in equipment and special composting premises (tunnels and bunkers).

The biggest part of hemicellulose and cellulose is lost during the first and second phases of the production due to the composting technologies which has been used thus far (FIG. 2).

Fig. The diagrams 1 and 2 are presented which reflect only one from currently known farms which practices the preparation of the champignon substrate by the method of composting, however each producer applies a slight different process of composting and different components, therefore the quantities of the useful materials and their composition may differ in different substrate preparation companies.

In the last few years the process of composting has been getting increasingly shorter. The aim is to reduce the amount of the burned (decomposed) materials and to leave as much as possible thereof to mushrooms, however the process mainly takes places thanks to the propagation of bacteria and thermophilous fungi. But the process of propagation of the bacteria and hermophilous fungi depends on variety of different factors, for example, substrate moisture, amount of oxygen in the substrate, temperature conditions, acidity, the components of the substrate, etc. Therefore every time the process of composting is different and it requires constant adjustment. It is practically impossible to create a programme for the compost production where the same components would be always chosen and the same conditions would be always established. Each separate process has its own peculiarities therefore it has to be adjusted individually not only during the preparation of the substrate but also during the other stages (phases) of the mushroom growing. As it is difficult to achieve repeatability the producers of the medium for the mushroom substrate usually choose the technology of the substrate which is more composted although it would result in the loss of higher amount of materials. Otherwise, the compost may not be sufficiently selective, pathogenic microorganisms may outrival the champignon mycelium and the anticipated yield may not grow enough or even may be completely lost.

During the last 30 years the production of champignons increased several times. At the beginning of the composting technology, the functions of the main components of the compost were carried out by the horse and chicken manure, which during at that time was plentiful and its price was cheap. However it was not enough due to the increasing volumes of the champignon substrate. Therefore, the horse manure had to be replaced by other source of the component of lignocellulose, that is, straw. As straw does not have sufficient amount of nitrogen in order to guarantee the process of composting in addition to straw the chicken manure was also used. Due to the growth of the global economy straw is no longer a waste but a valuable product which can be used in various areas. Therefore the price of straw, one of the components of the champignon substrate, is growing. The price also includes straw pressing and transportation.

The aim of this invention is to create a fundamentally new method for the preparation (production) of the substrate, suitable for growing various mushrooms (including champignons). The method would include the following steps.

During the step I, the processing of the parent materials (for example, straws of different plants, hey, corn stalks, wood ships and waste or other materials which contain lignocellulose biomass) occurs, by applying one of the known techniques of lignocellulose pre-processing (for example, stream explosion method, use of concentrated/diluted acids, application of thermochemical gasification, isolation/decomposition of the components of the said primary materials, processing by microwaves, processing by steam, application of hot liquid/water, etc.) in order to decompose the said parent material into the lower-level components and to obtain raw material. In order to attain the goal the method of steam explosion treatment is the most suitable. One of the advantages of this method is that it does not require any chemical additives and catalysts. It is very important that the prepared intermediate product should not have any toxic or unwanted chemical as the final product (mushrooms) are intended for human nutrition. When using the method of stream explosion, the parent material of lignocellulose is pulverized and placed into a reactor which operates under the continuous flow principle, the packet (portion) principle, or is of another type. The parent material which is brought (placed) into the reactor can be additionally wetted, also additional materials (catalysts) which stop or increase degradation can be added. Depending on the type/class of the parent material (for example, the said straw of different plants, corn stalks, wood ships or other materials which contain lignocellulose biomass), the parent material, located in the reactor, is heated by using steam up to approximately 160° C.-230° C. The pressure in the reactor reaches from approximately 12 up to 28 atmospheres. Such pressure is maintained for some time during which in the parent material a partial hydrolysis of cellulose and hemicellulose, decrystallization of cellulose and depolymerisation of lignin occurs. Afterwards the pressure in the reactor is immediately reduced to atmospheric pressure or (preferably) lower than atmospheric. At that time a sudden steam expansion (steam explosion) occurs and the whole chemical structure of lignocellulose is broken down. If the external pressure is lower than the atmospheric then the effect of the explosion is even stronger. During the explosion of steam the adiabatic process takes place during which an instantaneous cooling of ‘the exploded’ material occurs. During the cooling, the degradation processes slow down and the used materials are preserved.

During the step II, from the processed mass of lignocellulose (raw material) carbohydrates of the group C₅ can be removed, which decompose during the process of hemicellulose hydrolysis (or other effect). The carbohydrates of the group C₅ decompose partially during the said processing of the parent material so using different parent materials and different method of processing of the said parent materials different amounts of C5 are released from lignocellulose. C₅ (pentosanes) are separated and they can be used for the production of bioethanol, alcohol or other materials/products. One of the ways to separate can be washing of ‘the exploded’ material in hot water, where sugar elements of the group C₅ dissolve. Later, when using a centrifuge, pressing or other method, the liquid fraction (slurry) is separated from the solid fraction where mainly cellulose and lignin remains, undissolved in water carbohydrates of the group C₅ and/or other solid materials. If the elements of the group C₅ are not used for production of other, non-mushroom products, it is not necessary to perform such separation, but then the substrate has significantly more free sugars which are very suitable for the development of the competitive microflora.

During the step III, after the removal of the group C₅, the said raw material (initial substrate) is extruded to the level of optimal moisture, suitable for growing mycelium. The level of extrusion depends from the species of the mushrooms grown and is/can be different.

During the step IV: if additional, the substrate enriching materials, which are planned to be mixed to the substrate, are not microbiologically clean, then they should be pasteurized or sterilized.

During the step V, the aforementioned (in the step IV) additional, substrate enriching materials, that is, components of the substrate, which enrich the substrate with proteins, minerals or other materials required for growing of mycelium and mushrooms, are added to the wetted initial substrate. In case of different mushrooms, the quantities of the said additional materials are different and depend on the materials of the initial processing and its method. As, compared with the amount of the lignocellulose material, a relatively small quantity of the said additional materials is used, therefore it is more economically cost effective to pasteurize and sterilize additional materials separately than to process the whole mixture of the substrate.

During the step VI, the mycelium is undersown (inoculated) into the wetted and enriched initial substrate. The mycelium is mixed evenly/uniformly over the entire volume of the substrate and locally in a specific part of the substrate.

The further process of growing of mushroom is known at the technical level and has not been detailed further.

Depending on the species or subspecies of the mushrooms grown, all the aforementioned steps of the new method can have various different variations and somewhat differ quantitatively. For example, for champignons, before sowing the mycelium, in order to prevent the development of competitors, it is desirable to raise the selectivity of the substrate mixture. In order to achieve the goal, before or after the addition of the additional materials, after the parent materials of lignocellulose have been processed the thermophilic fungi are undersown (inoculated) into the substrate. During the propagation, the fungi break down carbohydrates, a part of cellulose and hemicellulose. The most useful species of the thermophilic fungi are Scytalidium thermophilum (Torula thermofila, Humicola insolens), Myriococcum thermophilum, C. thermophile, M. sulfurea or their mixture, which thrive under the temperature of approximately 45° C. Depending on the parent materials used and sterility of further process of growing, the colonization time of thermophilic fungi can change from few hours to several days. The more clean (sterile) conditions are guaranteed after the undersown (inoculation) of the mycelium into the substrate colonized with thermophilic fungi the lower substrate selectivity is required (and vice versa). Also, the longer the substrate medium with thermophilic fungi is conditioned, the greater the loss of materials necessary for the champignon, however the risk (possibility) of the spread of infection is also reduced. The thermophilic fungi form a biomass which becomes a source for carbohydrates, nitrogen and phosphorus, also it guarantees approximately few times faster growth rate of the champignons. Faster growth rate of the mycelium allows to guarantee protection from the competitive microorganisms because after full incubation of the mycelium the risk of infecting the substrate significantly decreases.

After the incubation period of thermophilic fungi, the substrate is cooled to the optimum temperature of 24-26° C., and the mycelium of the champignon-type mushrooms (for example, Agaricus bisporus, Agaricus bitorquis) is undersown (inoculated). The mycelium is uniformly mixed in the substrate mass. The further process of the said champignon growing is basically known and does not differ from the one which is used at the present.

In comparison with the substrates produced by the method of composting the substrate, for example, for champignons (Agaricus bisporus, Agaricus bitorquis), produced by this new method contains twice as much useful cellulose and hemicellulose derivatives. The reason is the preparation process of such substrate which is relatively short (when applying this method it takes up to 48 hours while the old method requires 7 days) and during its preparation the loss of the hemicellulose and cellulose complexes is lesser (FIG. 2)

In comparison with the substrates produced by the method of composting, this new method of the compost preparation guarantees that mushrooms easily absorb cellulose and hemicellulose which are contained in the substrate, because, during the processing of the parent materials, lignocellulose is degraded artificially to the required level of degradation. When applying the method of composting it is not possible to reach uniform degree of the same decomposition in each part of the substrate. Therefore the substrate produced by the new method can be also used separately, and also as an additive, to enrich the produced substrates with the cellulose and hemicellulose complexes because, as we see in FIG. 2, during the process of the mushroom growing the most notable decrease can be noticed in the quantities of cellulose and hemicellulose. The more the substrate is fermented the better the cellulose additive works. It is recommended to add the said additive/supplement to the substrate after the outgrowing of the mycelium, because, in comparison with the mass of the additive, the more champignons there will be at the moment of bringing additives to the mycelium biomass the faster and more qualitatively the mycelium will root in the additive and it will not be spoilt by competitive microorganisms.

When producing the substrate by this method, after the preparation of the substrate it is possible to dry it, compact it and to prepare it for transportation operations. The substrate can be compacted by all currently known methods, for example, by pressing, by applying granulation technology, etc. The new substrate can be dried because after the processing stage of the parent materials the material obtained is characterized by significantly (even several times) better hydrophilic properties, therefore such a dried material can be easily brought back to its working state that is, it is possible to restore its normal, suitable for the growing of mushrooms moisture level. The drying of the substrate is necessary in order to reduce to the minimum the possibility of the development of the competitive microorganisms in the substrate in comparison with the substrates which are produced now, the dried and compacted substrate can be stored in a warehouse for a significantly longer time prior to its utilization (before sowing). Also, the substrates produced by the method of composting have approximately only 30 to 40% of dry materials by weight, therefore the biggest proportion of the transportation costs basically consists of the transportation of water. The substrate produced, dried and compacted according the method is much easier and cheaper to transport: in terms of weight, in such a substrate the content of dry matter can reach even 95% of the gross weight of the substrate. After the delivery of the substrate to the production area, water is added to the substrate, the substrate is uniformly stirred and moisture level returns to the optimum level. Later, the mycelium is undersown into the substrate medium and the incubation process begins.

If the substrate is applied as an additive (supplement) in order to enrich the growing medium, then it is not necessary to wet it after the delivery to the production area. It is evenly stirred in the already uniformly wetted substrate. If the said additive the main part thereof consists of cellulose and hemicellulose is prepared in pellets or any other aggregated form then the absorption process of the additive will take longer but it will be more gradual.

If it is desired that the materials contained in the additives would be more slowly absorbed by the substrate or if the additive enriched substrate is not homogenous and/or may have hazardous (unwanted) pathogen, then the pellets of the cellulose additive or other compacted particles (parts) can be covered with a coating which would prevent from penetration of moisture and in such a way prevent the development of pathogen and the use the materials contained in the additive until the mycelium is not fully rooted and stronger. Basically all known coating techniques are suitable for the coating of the said additives. The function of coating can be also carried out by using various forms of organic acids which will protect for some time the cellulose additive from unwanted microorganisms. Later, the surfaces of the pellets fully overgrow with the mycelium which, by releasing enzymes, completely overcomes the coating, that is, grows into the particles (pellets) of the additive and absorbs the useful materials contained in the said pellets of the additive (or the aforementioned various aggravated forms).

When the substrate is used as the main substrate (not as an additive) it is prepared to be transported in large blocks, then after the transportation it should be pulverized to such a level that the size of the pulverized particles should be appropriate and optimal for the growth of the mycelium, that is, that the mycelium could grow qualitatively and uniformly on the outside and into the particles of the substrate.

The substrate produced by the new method is more advanced for several reasons in case of pleurotus ostreatus or other similar mushrooms feeding on the lignocellulose complex (for example, Bruno Shimeji, Maitake, Erengyii, Shi-take, Lentinula edodes, Pleurotus spp., Auricularia spp., Vovariella volvacea, Flammulina velutipes, Tremella fuciformis, Hypsizigus marmoreus, Pholiota nameko, Grifola frondosa). When using the usual method, the parts of the substrate mixture are only pasteurized or sterilized therefore basically only the problem of the infection of the competitive pathogen is solved. The raw material processed by the method of this invention becomes much more accessible for the enzymes of the mycelium; therefore the mycelium can overgrow the substrate faster and more uniformly and get inside the particles of the substrate. For this reason cellulose and hemicellulose can be used more effectively during the growing of the mycelium and of the mushroom fruit bodies. The substrate produced by the method of this invention is much easier to saturate with water and it is easier to reach the required optimum moisture level of the substrate. It is especially important if the substrate produced by the new method is dried and compacted. Whereas the application of the method of steam explosion when the temperature at the said reactor reaches or exceeds 200° C. destroys all pathogen located in the portion of the parent materials prior to the processing.

In order to increase the selectivity and resistance of the substrate to the competitive microorganisms of the mycelium, the lignincellulose, processed by the aforementioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (not necessarily this temperature, it can be any other optimum temperature).

In order to illustrate and describe the invention, the most appropriate implementation options are described above. This is not an exhaustive or limiting invention aiming to determine an exact form or implementation option. The aforementioned description should be perceived as an illustration and not as a limitation. It is evident that for professionals of the field there may be obvious many modifications and variations. Implementation options are selected and described in order the specialists of the field to provide the best explanation of the principles of the invention and their best practical application for different implementation options with different modifications suitable for a particular usage or application of implementation because in case of a particular mushroom species or subspecies the quantitative indicators of the implementation of the option may differ. The scope of the invention is specified in its claims and its equivalents where all said terms have meaning at the widest limits unless it is specified otherwise. It must be recognized that in relation to the implementation options, described by professionals of the relevant field, modifications may be made without deviating from the scope of the invention, as it is presented in the following claims.

### MODE FOR THE INVENTION

### Mode for Invention

### INDUSTRIAL APPLICABILITY

### Sequence Listing Free Text

Sequence List Text

1-5. (canceled)

6. A method of the substrate production for growing of champignons and other cultivated mushrooms encompasses the following:
mixing and stifling of various parent materials, wetting of the formed mixture, pasteurization, sterilization, cooling, undersowing of mycelium, mixing in the cooled medium, also incubation of the substrate;
wherein it includes the following steps:
the processing of the parent materials (for example, straw of different plants, hey, cottonseed hulls, corn stalks, wood ships or other materials which contain lignocellulose biomass) by applying one of the known methods of lignocellulose pre-processing (for example, stream explosion method, use of concentrated/diluted acids, application of thermochemical gasification, isolation/decomposition of the components of the said primary materials, processing by microwaves, application of steam, application of hot liquid/water, etc) in order to decompose the said parent material into the lower-level components and to obtain raw material;
the possible removal of the carbohydrates of the group C₅, which decompose during the process of hemicellulose hydrolysis (or other effect), from the processed mass of lignincellulose (the step can be skipped, if necessary);
the removal of the moisture surplus which was released by the said initial raw material during the possible removal of the groups C₅;
the extrusion and/or wetting of the said raw material up to the optimum moisture level suitable for the growth of the mycelium;
if additional, the substrate enriching materials, which are planned to be added to the said initial substrate, are not microbiologically clean then the pasteurization or sterilization of the said additional, the substrate enriching materials in order to destroy all pathogenic (infection) microorganisms;
the adding of the said components, which enrich the initial substrate with proteins, minerals and other minerals required for the growth of the mycelium and mushrooms, to the said wetted, initial substrate;
the undersowing (inoculation) of the mycelium, mixed evenly/uniformly over the entire volume of the substrate or locality in a specific part of the substrate, into the wetted and enriched initial substrate (substrate);
and, by comparing this method with the substrate produced by the old composting method, ensures the following special features:
in the substrate (the new substrate), produced by this method, approximately a twice larger amount of the useful derivatives/complexes of cellulose and hemicellulose remains;
the process of the preparation (production) of the new substrate is significantly shorter (the current process of composting may take from one week to three weeks while the said new method, depending on the species of the cultivated mushrooms, prepared the substrate within 2 days, sometimes within few hours);
during the preparation of the new substrate lignocellulose is broken down artificially up to the desired level of degradation when during the application of the usual composting method it is not possible to reach uniform, same degree of the decomposition and the level of the degradation of each part of the substrate;
when applying the method of the invention, after the processing lignocellulose absorbs water significantly better thus is it easier and more evenly to reach uniform level of humidity of the substrate.

7. The method of the substrate production according to claim 6, wherein the said method of the substrate production includes the steps of the substrate drying and compacting which help to ensure:
lighter, cheaper and more comfortable transportation,
longer storage time (depends on drying intensity,
from several months to a year), when the substrate produced by the currently known technology must be used within few weeks.

8. The method of the substrate production according to claim 7, wherein the said method of the substrate production includes the step of the substrate wetting which helps to ensure:
good application of the substrate as the main substrate after transportation and/or (longer) storing;
good application of the substrate as an enriching additive, added to other additives and to the substrates produced by different methods after transportation and/or (longer) storing;
where the step of the successful substrate wetting is ensured by the parent materials, processed by the method of this invention and characterized by better (easier) water (approximately twice) absorption.

9. The method of the substrate production according to claim 6, wherein the processing of the said parent materials takes place by applying the steam explosion method.

10. The method of the substrate production according to claim 7, wherein the processing of the said parent materials takes place by applying the steam explosion method.

11. The method of the substrate production according to claim 8, wherein the processing of the said parent materials takes place by applying the steam explosion method.

12. The method of the substrate production according to claim 6, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (or any other optimum temperature).

13. The method of the substrate production according to claim 7, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum themophilum, C. thermophile, M. sulfurea or their mixtures, which develop (grow) under the temperature of approximately 45° C. (or any other optimum temperature)

14. The method of the substrate production according to claim 8, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (or any other optimum temperature).

15. The method of the substrate production according to claim 9, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (or any other optimum temperature).

16. The method of the substrate production according to claim 10, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (or any other optimum temperature).

17. The method of the substrate production according to claim 11, wherein in order to improve selectivity and resistance of the substrate to the competitive microorganism of the mycelium, the lignincellulose, processed by the aformentioned methods, is inoculated with various thermophilic fungi, the most useful species thereof are: Scytalidium thermophilum (Torula thermofila, Humicola insolens), Myriococcum thermophilum, C. thermophile, M. sulfurea or their mixtures, which develop (grow) under the temperature of approximately 45° C. (or any other optimum temperature).
